(19) United States
(12) Patent Application Publication
(10) Pub. No.: US 2019/0152750 A1
(43) Pub. Date: May 23, 2019

(54) BOOM ARRANGEMENT, PERSONNEL HOIST AND METHOD OF USING PERSONNEL HOIST

(71) Applicant: Bronto Skylift Oy Ab, Tampere (FI)

(72) Inventor: Olli KOKKONEN, Nokia (FI)

(73) Assignee: Bronto Skylift Oy Ab, Tampere (FI)

(21) Appl. No.: 16/092,127

(22) PCT Filed: Apr. 7, 2017
(86) PCT No.: PCT/FI2017/050252

§ 371 Date: Oct. 8, 2018

(30) Foreign Application Priority Data
Apr. 8, 2016 (FI) 20165305

(51) Int. Cl. B66C 23/84; B66F 11/04

(52) U.S. Cl. CPC B66C 23/84; B66F 11/046

(57) ABSTRACT

The present disclosure relates to a boom arrangement and a personnel hoist, and associated method of use. The boom arrangement includes a boom, a man cage, a pivoting frame connected to the boom, a base for supporting the arrangement and a turning joint for turning the pivoting frame. A mechanical parting joint allows the boom arrangement to be divided into two boom units. The parting joint is located in a section between a lower end of the boom and the base, and the parting joint is separate from the turning joint.

### BACKGROUND OF THE INVENTION

The invention relates to a boom arrangement intended for a personnel hoist. The boom arrangement comprises a boom provided with a man cage and is connected to a pivoting frame so that the boom may lifted and lowered. The pivoting frame may be turned laterally relative to vertical axis by means of a turning joint. The boom arrangement further comprises a base, which is mounted to a structure of a carrier of a personnel hoist and provides support for the boom arrangement.

The invention further relates to a personnel hoist and a method of using the same.

The field of the invention is described in greater detail in the preambles of the independent claims of the application.

Personnel hoists are used e.g. in building construction works and different maintenance duties. When the hoists are provided with great reach ranges, they are heavy in weight and also large in size. Such high reach hoists are needed when servicing modern windmills, for example. Transportation of such big vehicles on public roads needs to be done utilizing special arrangements. Then, oversized and overweight transports are needed. Unfortunately, these transportations require careful preliminary planning, exceptional routings, use of special warning vehicles and other special arrangements. Typically, official permissions are also needed for such exceptional road transportations. Therefore, transportation of high reach personnel hoists is difficult, time consuming and expensive.

### BRIEF DESCRIPTION OF THE INVENTION

An object of the invention is to provide a novel and improved boom arrangement, personnel hoist and method of using the personnel hoist.

The boom arrangement of the invention is characterized by the features of the characterizing part of the first independent apparatus claim.

The personnel hoist of the invention is characterized by the features of the characterizing part of the second independent apparatus claim.

The method of the invention is characterized by the features of the characterizing part of independent method claim.

An idea of the disclosed solution is that the boom arrangement intended for personnel hoist comprises pre-planned parting means for dividing the boom arrangement into two boom units. A first boom unit may be separated and may be transported separately relative to a second boom unit and a vehicle or carrier of the hoist. The boom units are connected to each other by means of a mechanical parting joint. The mechanical parting joint is separate from a turning joint. Further, the parting joint is located at the boom arrangement between a section extending from a lower end of the boom to the base. Thereby, the boom, which may comprise two or more boom parts, joints, sensing means, pressure medium channels and electric wires remains demounted. However, different alternative mechanical solutions and parting joint locations may be employed at the bottom part of the boom arrangement. The parting joint may be a dedicated joint intended only for the disclosed parting feature and having no other usage.

Further, the personnel hoist may be considered to have a transportation mode wherein the boom arrangement is prepared to road transportation by dividing it into two units. The first separated boom unit may be transported as a separate transport relative to the second boom unit, which is transported together with the carrier. Then, two smaller items are transported on public roads instead of one exceptionally large entity. The personnel hoist further comprises an operational hoisting mode, wherefore the boom arrangement is prepared after the road transport for the hoisting mode by coupling the separated boom units to each other.

An advantage of the disclosed solution is that preparations of the boom arrangement for the hoisting operation and the road transportation are relatively easy and quick to execute. Therefore, the preparatory work causes only relatively short downtimes for the personnel hoist. Thanks to the transport mode, the personnel hoist may be transported on public roads without any special permissions and driving arrangements. Therefore, time and money is saved and the hoist may be utilized effectively and flexibly at different work sites.

Since the disclosed parting occurs only at the dedicated mechanical parting joint, the turning joint maintains its settings and there is no need for any adjusting measures and means.

According to an embodiment, the boom arrangement comprises only one single parting joint for dividing the boom arrangement into two boom units when preparing the boom arrangement for road transportation.

According to an embodiment, the parting joint of the boom arrangement comprises only mechanical fastening means between the boom units. Thus, the parting joint is without any other connectable elements.

According to an embodiment, the parting joint of the boom arrangement is serving only for transmitting mechanical forces between the boom units of the boom arrangement. Thereby, the parting joint may be designed only for this purpose and it may be relatively simple in structure.

According to an embodiment, the parting joint of the boom arrangement is without any fluid and electric connectors. Thereby, connecting of such parting joint is fast and easy when no coupling of the connectors needs to be done.

According to an embodiment, the parting joint of the boom arrangement is without any control means or elements. Thus, the parting joint is dedicated for mechanical fastening and is without any limit switches, measuring devices, sensing elements or sensors. However, the turning joint, which is located separately relative to the parting joint, comprises control elements for detecting turning operation of the boom. The limit switches, detectors, sensors or measuring devices of the turning joint are for detecting the direction of the boom. The disclosed parting of the boom arrangement has no effect on the control elements of the turning joint, whereby settings of the control elements remain unchanged.

According to an embodiment, the boom arrangement may comprise connectors for connecting its systems to one or more pressure medium, control and electrical systems. The connectors are located at ends of flexible passages, such as pressure medium hoses and electric wires, which extend unbroken over the parting joint. Thus, the detachable first boom arrangement unit comprises free length of the flexible passages, so that the connection of the flexible passages may be executed at a remote connection point, which is located at a distance from the parting joint. An advantage of this is that the connections may be executed at better conditions. The connection point may be arranged so that there is enough space for the connecting work and that the connecting point is protected against dirt, moisture and dents, for example. The connectors may be hydraulic connectors, pneumatic connectors, electric power connectors, sensing signal connectors, control signal connectors or any other needed connectors. The connectors are located external relative to the parting joint. Further, the connectors may be located at a separate connecting box, which is located at a distance from the parting joint. The connecting boxes may be located on sides of a carrier of the personnel hoist, for example. Furthermore, such connectors may be quick connectors whereby no special skills or tools are needed for coupling and decoupling the hoses and wires.

According to an embodiment, the parting joint of the boom arrangement is located at a vertical section between the turning joint and the base, whereby the parting joint is located underneath the pivoting frame. Thanks to this solution the disclosed parting measures do not cause any need to demount and mount any actuator of the boom arrangement, which facilitates and quickens the demounting and mounting. Further, since the actuators maintain their factory settings, there is no need for re-adjustments and measuring.

According to an embodiment, the boom arrangement comprises an intermediate element arranged between the turning joint and the base. The base may be mounted to a carrier of the personnel hoist and it may comprise mounting surfaces facing towards the intermediate element. The intermediate element is arranged vertically and comprises a first end and a second end. The first end is facing towards the pivoting frame and comprises support surfaces for turning elements of the turning joint. The second end is facing towards the base and comprises first fastening surfaces and is part of the parting joint. In this embodiment, the parting joint is between the intermediate element and the base. The base may be the only component or element of the boom arrangement that is left on the carrier when dividing the boom arrangement into two part. Thanks to the intermediate element, the parting joint is easy to arrange underneath the pivoting fame and the turning joint. Structure of the intermediate piece may relatively simple.

According to an embodiment, the boom arrangement comprises an intermediate element arranged between the turning joint and the base. The intermediate element is an elongated hollow element comprising an inner space allowing the flexible passages to pass through the element. The intermediate piece may comprise cylindrical, tubular or other kind of hollow structure which may be rigid but still light in weight, and which provides a protected shell for fluid hoses and electric wires.

According to an embodiment, the boom arrangement comprises an intermediate element arranged between the turning joint and the base. The elongated intermediate element is in accordance with the previous embodiment. The first end comprises a first flange and the second end comprises a second flange, whereby the flanges serve as axial mating surfaces. Between the end flanges is an elongated hollow intermediate section.

According to an embodiment, the base comprises an upward protruding mounting part, which is provided with second fastening surfaces facing towards the first fastening surfaces of the intermediate element.

According to an embodiment, the boom arrangement comprises an intermediate element arranged between the base and the turning joint. A lower end of the intermediate element comprises a first fastening surface and the base comprises a mating second fastening surface. Between the first and second fastening surfaces is screw fastening. In connection with the first and second fastening surfaces are mating fastening holes through which fastening screws are arranged for connecting the fastening surfaces to each other.

According to an embodiment, the boom arrangement comprises a parting joint, which is located at a section between a lower part of the boom and the turning joint. Thus, in this embodiment the parting joint is located above the turning joint.

According to an embodiment, the boom arrangement comprises a parting joint, which is located in connection with the pivoting frame of the boom arrangement.

According to an embodiment, the pivoting frame of the boom arrangement comprises a top part and a bottom part between which is the parting joint.

According to an embodiment, the pivoting frame of the boom arrangement comprises two upwardly projecting support structures, such as support lugs, between which is an intermediate space allowing lowermost portion of the boom to enter the space when the boom is lowered relative to the horizontal joint between the boom and the pivoting frame. The support structures are provided with top elements, which are demountable from the support structures and comprise the horizontal joint. Upper parts of the support structures comprise mounting surfaces facing towards the top elements. Parting joints are located between the demountable top elements and the mounting surfaces of the support elements. Thus, the two detachable top elements form the top part of the pivoting frame and the rest of the pivoting frame structure forms the bottom part of the pivoting frame. The two detachable top elements both comprise the horizontal joint.

According to an embodiment, the pivoting frame of the boom arrangement comprises two upwardly projecting support structures, such as support lugs. Top parts of the support structures are provided with detachable top elements. Upper surfaces of the support structures and lower surfaces of the detachable top elements are provided with cavities so that they form together support spaces for receiving a connection pin or joint assembly of the horizontal joint. Thus, in this embodiment the parting joint is between the bottom part of the support lugs and the detachable top elements, and the parting joint is located at the horizontal joint. The connection pin or joint assembly remains connected to the boom when the disclosed parting is executed.

According to an embodiment, top elements of the support structures of the pivoting frame are separated during the demounting together with the boom. Thus, the top element remains connected to a lower end of the boom by means of horizontal joint assemblies. The parting joint is located between upper portions of the supporting structures and the top elements.

According to an embodiment, top portions of the support structures, such as support lugs, of the pivoting frame are provided with horizontal joint assemblies, which are laterally movable to a locking position for connecting the boom, and to a release position for releasing the connection between the pivoting frame and the boom. In this embodiment the upper portions of the support structures comprise transversely movable connection means, which serve as the horizontal joint. The parting joint is formed between the horizontal joint assemblies and a mating transverse connecting hole, which is located at a lower end of the boom.

According to an embodiment, the parting joint of the boom arrangement comprises at least one aligning element determining pre-designed alignment between the connected components. Thanks to the aligning elements, the boom is always mounted to a designed direction and there is no need to adjust the direction or components of a control and sensing systems. Furthermore, the aligning elements facilitate and quicken the mounting of the boom units at the work site. When the mating surfaces are connected to each other by means of fastening screws or corresponding elements, the aligning elements ensure that mating fastening openings will match. The aligning elements ensure the correct alignment and leave no possibility to human errors.

According to an embodiment the at least one aligning element is positioned asymmetrically in the parting joint. According to an embodiment the parting joint comprises at least two aligning elements determining a pre-designed alignment between the connected components and the at least two aligning elements are positioned asymmetrically in the parting joint. When the one or more aligning elements are positioned asymmetrically in the parting joint it is thereby reliably ensured that the boom units to be connected are at a correct location and orientation before coupling the boom units together.

According to an embodiment, the parting joint of the boom arrangement comprises one or more aligning elements defining a reference position for the boom relative the base or carrier. The accurate reference position may be utilized in some position measuring and control systems, for example.

According to an embodiment, the parting joint of the boom arrangement comprises at least two aligning pins and corresponding amount of aligning openings or cavities for providing simple and reliable system for securing correct alignment of the boom relative to the base and carrier.

According to an embodiment, the parting joint of the boom arrangement comprises mating fastening flanges provided with several fastening openings. The parting joint further comprises several fastening screws for fastening the mating fastening surfaces to each other. In other words, screw fastening is utilized at the parting joint. Screw fastening is simply, does not require special tools, and is inexpensive and reliable.

According to an embodiment, the parting joint of the boom arrangement comprises mating horizontal fastening flanges provided with several vertical fastening openings passing through the fastening flanges; and the parting joint further comprises several fastening screws which pass through the fastenings openings and are tightened by means of fastening nuts.

According to an embodiment, the parting joint of the boom arrangement comprises quick coupling means for fastening the mating fastening surfaces to each other. According to an embodiment the parting joint comprises mating fastening flanges and hydraulic quick-release fasteners for fastening the mating fastening surfaces to each other.

According to an embodiment, the parting joint of the boom arrangement comprises at least one locking actuator for fastening the mating fastening surfaces to each other. The parting joint comprises overlapping portions which are lockable to each other by means of the one or more locking actuators. The locking actuator is connected to one of the overlapping portions and is provided with a friction element which is pressed against another overlapping portion for generating a friction force between the connected elements. Alternatively, the one or more locking actuators may be configured to generate a shape locking between the overlapping portions.

According to an embodiment, the parting joint of the boom arrangement comprises at least one locking actuator for generating shape locking for fastening the mating fastening surfaces to each other. The locking actuator may be configured to turn one or more locking elements around vertical axis of the parting joint. The locking may be based on a so called bayonet coupling.

According to an embodiment, the parting joint of the boom arrangement comprises at least one fastening pin. The pin may be part of the horizontal joint. Alternatively, the pin may be vertical and may be configured to fasten a bearing assembly or bracket element to an upper portion of the pivoting frame.

According to an embodiment, the base of the boom arrangement is connected immovably to a carrier of the personnel hoist. The base is configured to direct support forces between a basic frame structure of the carrier and the boom arrangement.

According to an embodiment, the personnel hoist comprises at least one control unit. The control unit is provided with at least one self-diagnosing program execution of which program in a processor of the control unit after mounting of the boom units together is configured to detect operational condition of the boom and related systems. In case even one deviation in the operational condition is detected, the control unit prevents operation of the hoist until the deviation is solved.

According to an embodiment, the boom is a boom assembly. Then the boom comprises two or more boom parts connected to each other by means of boom joints, whereby the boom parts may be moved in a versatile manner relative to each other. Further, one or more of the boom parts may comprise linear joints thereby allowing the boom part to be extended and retracted.

According to an embodiment, the boom arrangement is mounted on a carrier of a road vehicle such as a truck.

The above disclosed embodiments and features can be combined in order to form suitable solutions provided with necessary features.

### BRIEF DESCRIPTION OF THE FIGURES

Some embodiments of the disclosed solution will be described in greater detail with reference to the accompanying drawings, in which

FIG. 1 is a schematic side view of a personnel hoist in an operational hoisting mode;

FIG. 2 is a schematic side view of a personnel hoist which is prepared for a road transport mode by dividing a boom arrangement into two boom units;

FIG. 3 is a schematic side view of a feasible parting joint, which is located at a section between a turning joint and a base;

FIG. 4 is a schematic exploded view of the parting joint of FIG. 3 and the related components;

FIG. 5 is a schematic view of a pivoting frame comprising a horizontal joint provided with laterally movable joint assemblies for coupling and uncoupling a boom between them;

FIG. 6 is a schematic view of a pivoting frame comprising two upwardly directed support lugs provided with detachable top elements, and wherein parting joints are located between the top elements and the lugs;

FIG. 7 is a schematic view of a pivoting frame comprising two upwardly directed support lugs provided with detachable top elements, and wherein parting joints are at a horizontal joint;

FIG. 8 is a schematic view of a pivoting frame comprising two support lugs provided with fastening surfaces for receiving horizontal joint assemblies connected to a lower end of a boom, whereby parting joints are located between the lugs and the horizontal joint assemblies;

FIG. 9 is a schematic side view of a boom arrangement comprising a support module connectable to a base, which is located at rear end of a carrier, whereby the mounting and dismounting is executed by moving the support module in a longitudinal direction of the carrier;

FIG. 10 is a schematic side view of flexible fluid hoses passing unbroken over the parting joint to remote fluid connectors; and

FIG. 11 is a schematic side view of a rotating electric distribution system and wires passing unbroken over the parting joint and comprising electric connectors at a distance from the parting joint.

For the sake of clarity, some embodiments of the disclosed solution have been simplified in the figures. Like parts are denoted with like reference numerals.

### DETAILED DISCLOSURE OF SOME EMBODIMENTS

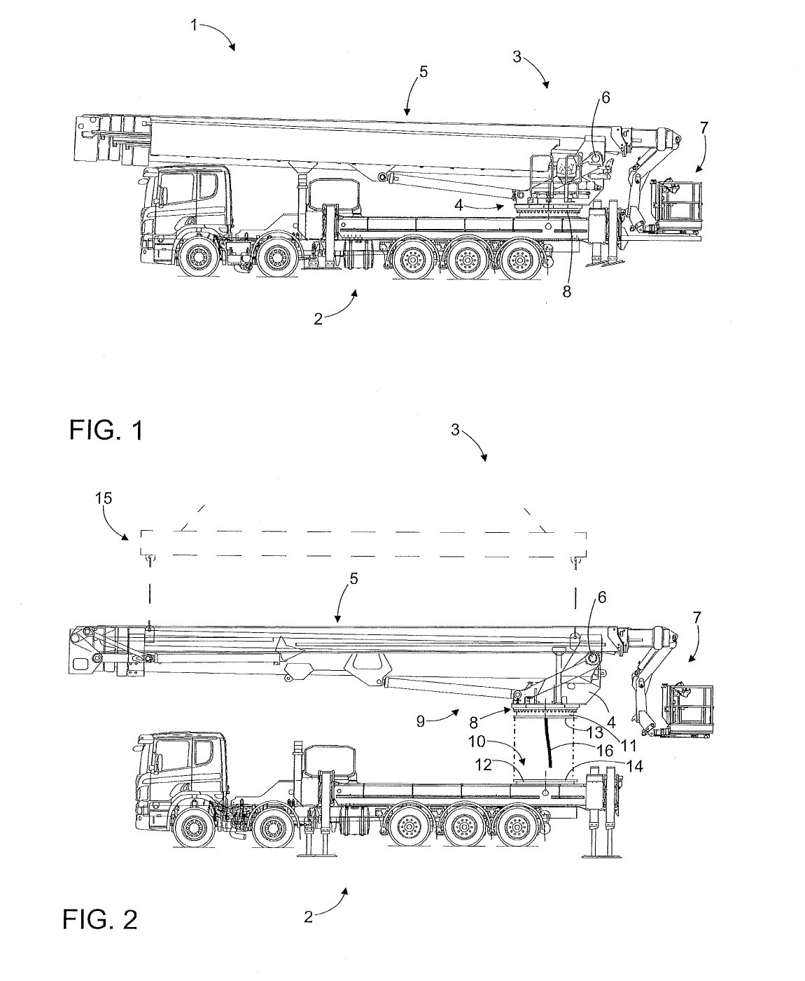

FIG. 1 shows a personnel hoist 1 comprising a carrier 2 provided with a boom arrangement 3. The carrier 2 may be a truck of other vehicle suitable for road transportation on public roads. The boom arrangement 3 is provided with a pivoting frame 4 to which the bottom end of a boom 5 is attached by a horizontal joint 6 so that the boom 5 may lifted and lowered relative to the horizontal joint 6. The boom 5 may comprise several articulated boom parts and actuators for moving the parts relative to each other. The top end of the boom 5 may be provided with a man cage 7 accommodating one or more persons to be lifted. By pivoting the pivoting frame 4 the boom 5 may be moved in a lateral direction. The pivoting frame 4 may be turned relative to vertical axis by means of a turning joint 8. The length of the boom 5 may be changed telescopically, which allows the boom 5 to be retracted for transport mode and extended into a desired length in operating mode. The personnel hoist 1 may have a very long reach. As number of high-rise buildings, windmills and other objects increase, personnel hoists 1 used in repair and service operations must allow ever greater heights to be reached. However, transportation of such vehicles on public roads is difficult and expensive because they are oversized and overweight.

FIG. 2 shows that personnel hoist 1 may be prepared for a road transport mode by dividing the boom arrangement 3 into two boom units 9, 10. In the solution disclosed in FIG. 2 a first boom unit 9 comprises the man cage 7, the boom 5, the pivoting frame 4, the turning joint 8 and an intermediate element 11 below the turning joint 8. A base 12 is fastened to a carrier 2. The base 12 is part of the boom arrangement 3 and in the solution of FIG. 2 the base forms a second boom unit 10. The lower part of the intermediate element 11 may comprise a fastening flange provided with a fastening surface 13, and the base 12 may also comprise a fastening flange provided with a corresponding fastening surface 14. When the fastening surfaces 13, 14 are arranged against each other and locked immovably to each other, a mechanical parting joint is formed between them. As can be seen, the first boom unit 9 may be lifted away by means of a crane 15 after fastening means of the parting joint are removed or loosened. This way, the first boom unit 9 may be separated as one entity from the second boom unit 10. The second boom unit 10, in this case the base 12, remains connected to the carrier 2. After the disclosed parting, the vehicle is significantly smaller is size and weight and may therefore be driven on public roads without special arrangements.

FIG. 2 further shows that flexible passages 16, such as fluid hoses and electric wires may pass over the parting joint in one piece so that there are no connectors at the parting joint. As can be seen, the flexible passages 16 may have free length so that they hang freely when the first boom unit 9 is lifted. Distal ends of the flexible passages 16 may be provided with fluid and electric connectors, whereby they can be connected at separate connection points.

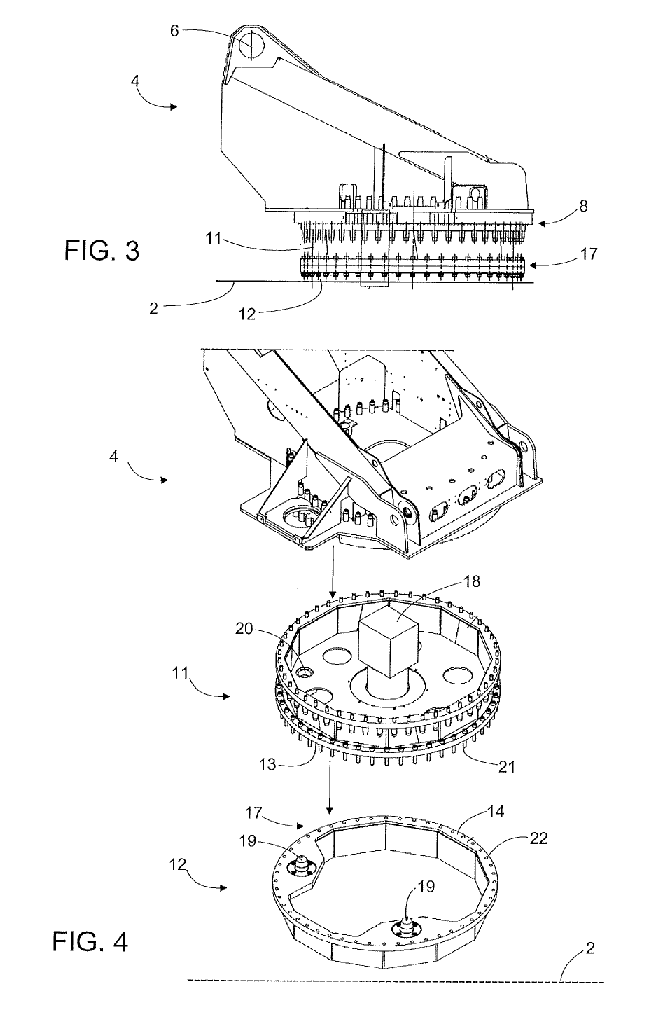

FIG. 3 discloses enlarged the parting joint 17 utilized in the boom arrangements of FIGS. 1 and 2. The parting joint 17 is located between a bottom end of the intermediate element 11 and a top end of the base 12. Between the pivoting frame 4 and the intermediate element 11 is the turning joint 8.

FIG. 4 shows the pivoting frame 4, the intermediate element 11 and the base 12 as separated components. Inside the intermediate element 11 may be an inner space provided with a rotating coupling device 18 for the flexible passages. The rotating coupling device 18 allows the pivoting frame to turn without transmitting the turning movement to the hoses and electric wires. Further, the base 12 may comprise aligning elements 19, such as pins, which may protrude to openings 20 of the intermediate element 11. The aligning elements 19 ensure correct alignment between coupled components at the parting joint 17, whereby fastening screws 21 match with fastening openings 22.

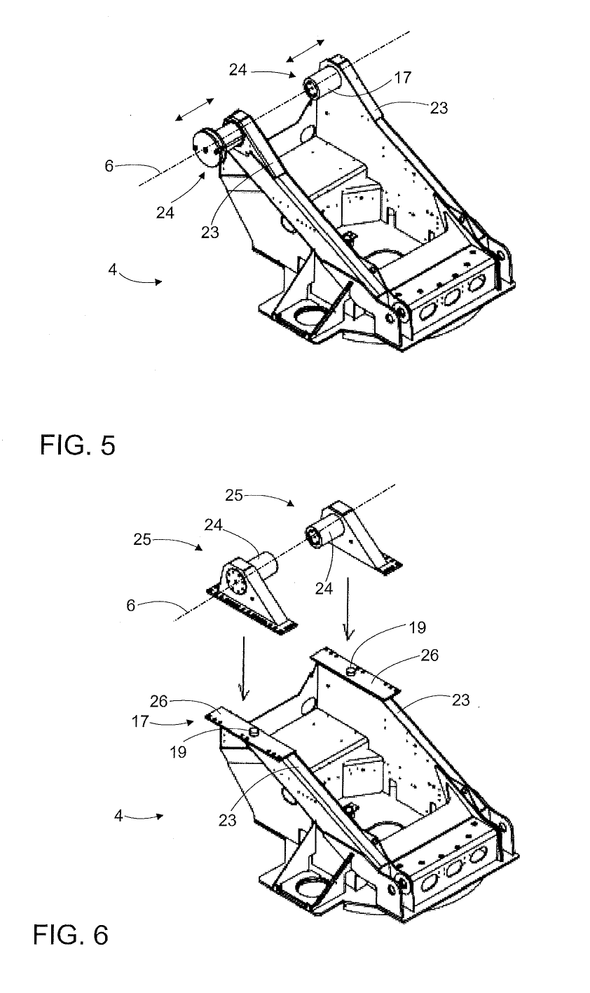

FIG. 5 discloses a pivoting frame 4 comprising two support lugs 23 top portions of which are provided with horizontal joint assemblies 24, which are laterally movable to a locking position for connecting a boom, and to a release position for releasing the connection between the pivoting frame 4 and the boom. In this embodiment a parting joint 17 is in connection with the horizontal joint 6.

In FIG. 6 a pivoting frame 4 of the boom arrangement comprises two upwardly projecting support lugs 23. The support lugs 23 are provided with top elements 25, which are demountable from the support lugs 23 and comprise horizontal joint assemblies 24 or means. Upper parts of the support lugs comprise mounting surfaces 26 facing towards the top elements 25. The mounting surfaces may also comprise aligning elements 19. Parting joints are formed between the top elements 25 and the mounting surfaces 26.

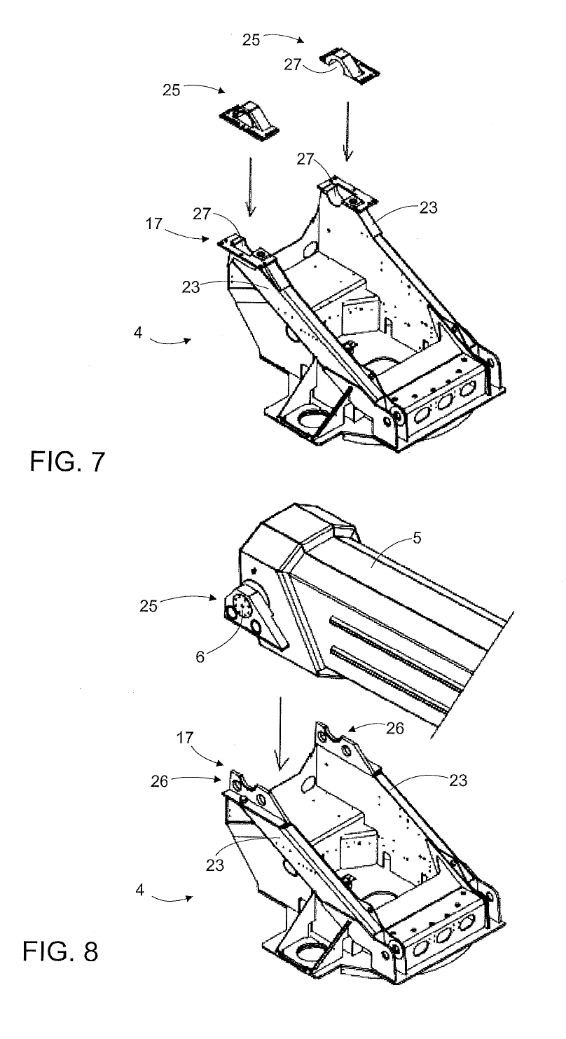

FIG. 7 discloses a feasible solution which differs from the solution of FIG. 6 in that the parting joint is formed at the horizontal joint. Therefore, the top elements 25 and the mounting surfaces 26 are provided with cavities 27 for receiving a connection pin or joint assembly of the horizontal joint.

FIG. 8 discloses an alternative solution wherein a top element 25 remains connected to a lower end of the boom 5 by means of a horizontal joint 6 when the first boom unit is separated. A parting joint 17 is formed between mounting surfaces 26 of the support lugs 23 and the top elements 25.

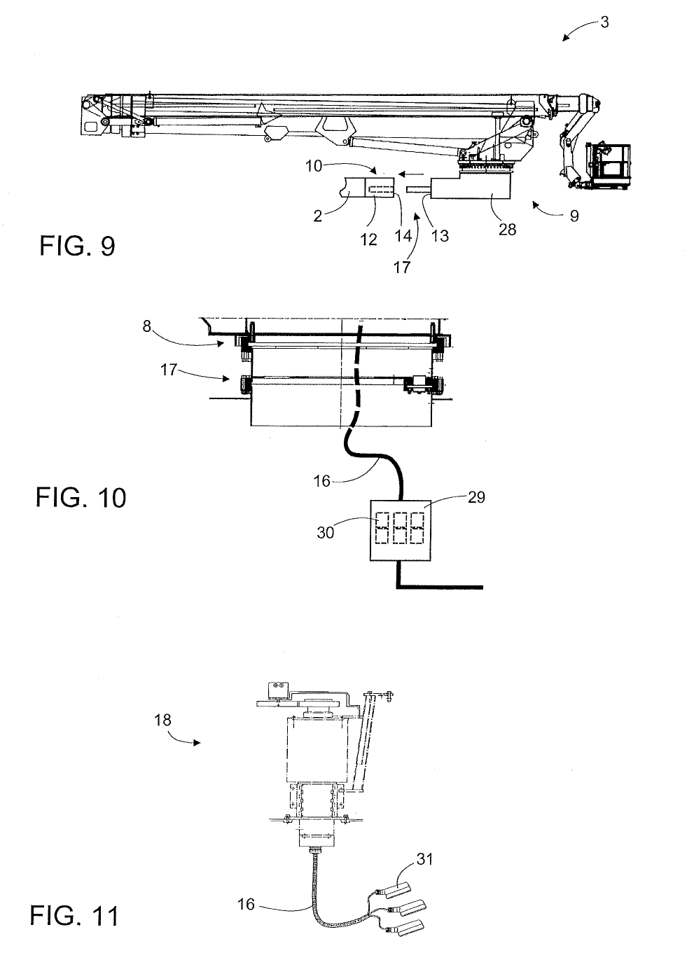

FIG. 9 discloses a boom arrangement 3 comprising a support module 28 connectable to a base 12, which is located at a rear end of a carrier 2. Mounting and dismounting of a first boom module 9 is executed by moving the support module 28 in a longitudinal direction of the carrier 2. A parting joint 17 may be vertical.

FIG. 10 shows that flexible fluid hoses 16 pass unbroken over a parting joint 17. The hoses 16 may be connected at a remotely located coupling box 29 to a fluid system. Lengths of the hoses 16 are dimensioned so that they extend to a connecting point and their ends are provided with connectors 30.

FIG. 11 shows an example of a rotating coupling device 18 or rotating electric distribution device. Electric wires 16 having extra lengths pass unbroken over the parting joint. Ends of the wires 16 are provided with electric connectors 31 for executing connection at a distance from the parting joint.

In some cases features disclosed in this application may be applied as such, independently of other features. On the other hand, features disclosed in this application may be combined, when necessary, to provide different combinations.

The drawings and the related specification are only intended to illustrate the idea of the invention. The details of the invention may vary within the scope of the claims.

1. A boom arrangement comprising:
a boom;
a man cage at a distal first end of the boom;
a pivoting frame;
a horizontal joint for connecting the boom to the pivoting frame and configured for allowing lifting and lowering of the boom relative to the pivoting frame;
a turning joint configured for turning of the pivoting frame around a vertical turning axis; and
a base for providing support for the boom arrangement;
wherein the boom arrangement is configured with:
a first boom unit; and
a second boom unit connected to the first boom unit by a mechanical parting joint between the boom units;
the first boom unit including at least the boom and the man cage, and the second boom unit including at least the base;
the parting joint between the first and second boom units is being demountable and mountable allowing thereby the boom arrangement to be divided into two boom units;
the parting joint is being located separate from the turning joint; and
the parting joint including at least one aligning element for determining pre-designed alignment between connected components of the first and second boom units.

2. The boom arrangement according to claim 1, wherein the parting joint comprises:
only a mechanical fastening means between the first and second boom units, whereby the parting joint is without any other connectable elements.

3. The boom arrangement according to claim 1, wherein:
the parting joint is located at a vertical section between the turning joint and the base, whereby the parting joint is located underneath the pivoting frame.

4. The boom arrangement according to claim 3, comprising:
an intermediate element arranged between the turning joint and the base; wherein:
the base includes comprises mounting surfaces facing towards the intermediate element;
the intermediate element being arranged vertically and having a first end and a second end;
the first end facing towards the pivoting frame and having support surfaces for turning elements of the turning joint; and
the second end facing towards the base and having first fastening surfaces and being part of the parting joint.

5. The boom arrangement according to claim 1, wherein:
the parting joint is located at a section between the boom and the turning joint.

6. The boom arrangement according to claim 5, wherein the pivoting frame comprises:
a top part and a bottom part between which is the parting joint.

7. The boom arrangement according to claim 1, wherein:
the at least one aligning element is positioned asymmetrically in the parting joint.

8. The boom arrangement according to claim 1, wherein the parting joint comprises:
at least two aligning elements determining pre-designed alignment between the connected components, the at least two aligning elements being positioned asymmetrically in the parting joint.

9. The boom arrangement according to claim 1, wherein the parting joint comprises:
mating fastening flanges provided with several fastening openings; and
the parting joint includes several fastening screws for fastening the mating fastening flanges to each other.

10. The boom arrangement according to claim 1, wherein the parting joint comprises:
mating fastening flanges and hydraulic quick-release fasteners for fastening the mating fastening flanges to each other.

11. A personnel hoist comprising:
a mobile carrier; and
a boom arrangement supported to the carrier; wherein the boom arrangement comprises:
a boom;
at least one man cage at a distal end portion of the boom;
a pivoting frame;
a horizontal joint for connecting the boom to the pivoting frame and configured for allowing lifting and lowering of the boom relative to the pivoting frame;
a turning joint configured for turning the pivoting frame around a vertical turning axis;
a base for supporting the boom arrangement to the carrier; and
a parting joint for dividing the boom arrangement into two separate boom units for transportation, and for coupling the two separate boom units to each other for a hoisting operation;
the parting joint being located separate from the turning joint; and
the parting joint having at least one aligning element for determining pre-designed alignment between connected components of the two separate boom units.

12. A method of using a personnel hoist, wherein the method comprises:
executing hoisting operations at a first work site;
transporting the personnel hoist to a second work site by utilizing road transportation;
preparing for the road transportation by dividing a boom arrangement of the personnel hoist into two boom units at a dedicated mechanical parting joint for providing the personnel hoist with a road transportation state;
preparing the hoisting operation after the road transportation by coupling the boom units together for providing the personnel hoist with an operational hoisting state; and
executing the preparing for road transportation and the hoisting operations of the first and second work sites without demounting and mounting a boom and a turning joint of the boom arrangement.

13. The method according to claim 12, comprising:
aligning the boom units before coupling the boom units together.

14. The method according to claim 12, wherein the personal hoist includes:
a mobile carrier; and
a boom arrangement supported to the carrier; wherein the boom arrangement includes:
a boom;
at least one man cage at a distal end portion of the boom;
a pivoting frame;
a horizontal joint for connecting the boom to the pivoting frame and configured for allowing lifting and lowering of the boom relative to the pivoting frame;
a turning joint configured for turning the pivoting frame around a vertical turning axis;
a base for supporting the boom arrangement to the carrier; and
a parting joint for dividing the boom arrangement into two separate boom units for transportation, and for coupling the two separate boom units to each other for a hoisting operation;
the parting joint being located separate from the turning joint; and
the parting joint having at least one aligning element for determining pre-designed alignment between connected components of the two separate boom units.
